(19) United States
(12) Patent Application Publication
(10) Pub. No.: US 2023/0140508 A1
(43) Pub. Date: May 4, 2023

(54) Cloud Processing Leveraging On-Premises Extract, Transform, and Load

(71) Applicant: SAP SE, Walldorf (DE)

(72) Inventors: Alexander Ocher, San Jose, CA (US); Sreenivasulu Gelle, San Ramon, CA (US); Anil Samudrala, Newark, CA (US); Shibajee Dutta Gupta, Tracy, CA (US); Manali Pise, Sunnyvale, CA (US); Xiaofan Zhou, Cupertino, CA (US); Hariharan Arumugam, San Ramon, CA (US); Mitchell Gudmundson, Colorado Springs, CO (US); Uillian Ludwig, Porto Alegre (BR); Abhishek Mohanty, Bangalore (IN); Mohana Andal M, Banalore (IN); Felipe Veronezi Peters, São Sebastião do Caí (BR)

(21) Appl. No.: 17/517,501

(22) Filed: Nov. 2, 2021

(51) Int. Cl. G06F 16/25

(52) U.S. Cl. CPC G06F 16/254

(57) ABSTRACT

Embodiments leverage local data available from an on-premises Extract, Transfer, and Load (ETL) job, in order to efficiently perform remote processing (e.g., as implemented on the cloud). Connectivity data (e.g., target setup) and ETL logic (e.g., configuring data flattening, pivot transform, and/or data quality transform) is stored locally in a non-transitory computer readable storage medium. In response to receiving data transformed on-premises, the transformed data, connectivity data, and ETL logic are forwarded to a remote location for processing. Some embodiments may also forward the transformed data on to its original target on-premises (e.g., via a local database loader). Particular embodiments may provide hidden, Representational State Transfer (REST)-based loader(s) that duplicate output of the local ETL job. Embodiments conserve developer effort by allowing preparatory local ETL data that is already available on-premises, to be read and used for processing in a remote cloud intelligence system.

### BACKGROUND

Unless otherwise indicated herein, the approaches described in this section are not prior art to the claims in this application and are not admitted to be prior art by inclusion in this section.

Extract, Transfer, and Load (ETL) processes are used to take data from a source and place it into a particular type of data store, such as a database. Formerly the data store was typically located on-premises, at a location local to a user.

More recently however, data stores have increasingly migrated to remote locations on the cloud. Furthermore, the software applications that seek to process the stored data to produce useful outcomes, have also increasingly migrated to cloud locations.

### SUMMARY

Embodiments leverage local data available from an on-premises Extract, Transfer, and Load (ETL) job, in order to efficiently perform remote processing (e.g., as implemented on the cloud). Connectivity data (e.g., target setup) and ETL logic (e.g., configuring data flattening, pivot transform, and/or data quality transform) is stored locally in a non-transitory computer readable storage medium. In response to receiving data transformed on-premises, the transformed data, connectivity data, and ETL logic are forwarded to a remote location for processing. Some embodiments may also forward the transformed data on to its original target on-premises (e.g., via a local database loader). Particular embodiments may provide hidden, Representational State Transfer (REST)-based loader(s) that duplicate output of the local ETL job. Embodiments conserve developer effort by allowing preparatory local ETL data that is already available on-premises, to be read and used for processing in a remote cloud intelligence system.

The following detailed description and accompanying drawings provide a better understanding of the nature and advantages of various embodiments.

### BRIEF DESCRIPTION OF THE DRAWINGS

FIG. 1 shows a simplified diagram of a system according to an embodiment.

FIG. 2 shows a simplified flow diagram of a method according to an embodiment.

FIG. 3 is a simplified block diagram of an embodiment system according to an example.

FIG. 4 shows a simplified view of an on-premises ETL job.

FIG. 5 shows connection information in the form of a configuration file.

FIG. 6 shows a variety of remote cloud processing applications that may consume data from the ETL job.

FIG. 7 illustrates hardware of a special purpose computing machine configured to leverage on-premises ETL to implement cloud processing.

FIG. 8 illustrates an example computer system.

### DETAILED DESCRIPTION

Described herein are methods and apparatuses that leverage on-premises ETL in order to perform cloud processing. In the following description, for purposes of explanation, numerous examples and specific details are set forth in order to provide a thorough understanding of embodiments according to the present invention. It will be evident, however, to one skilled in the art that embodiments as defined by the claims may include some or all of the features in these examples alone or in combination with other features described below, and may further include modifications and equivalents of the features and concepts described herein.

Over the years, commercial entities have developed numbers of ETL jobs in order to achieve data movement and processing needs at their physical premises. These on-premises ETL jobs continue to be employed.

It is noted that preparatory effort may be consumed in order to accomplish such ETL jobs on-premises. For example, there may be an investment in time setting up sources and targets. Such investment may take the form of, e.g., configuring Open Database Connectivity (ODBC) connections, and setting up File Transfer Protocol (FTP) transfers for the on-premises ETL jobs.

However, evolving technologies and requirements may call for subsequent processing of the results of on-premises ETL, remote from the premises of the user. Such further cloud processing may reference the ETL logic, and related connectivity setups.

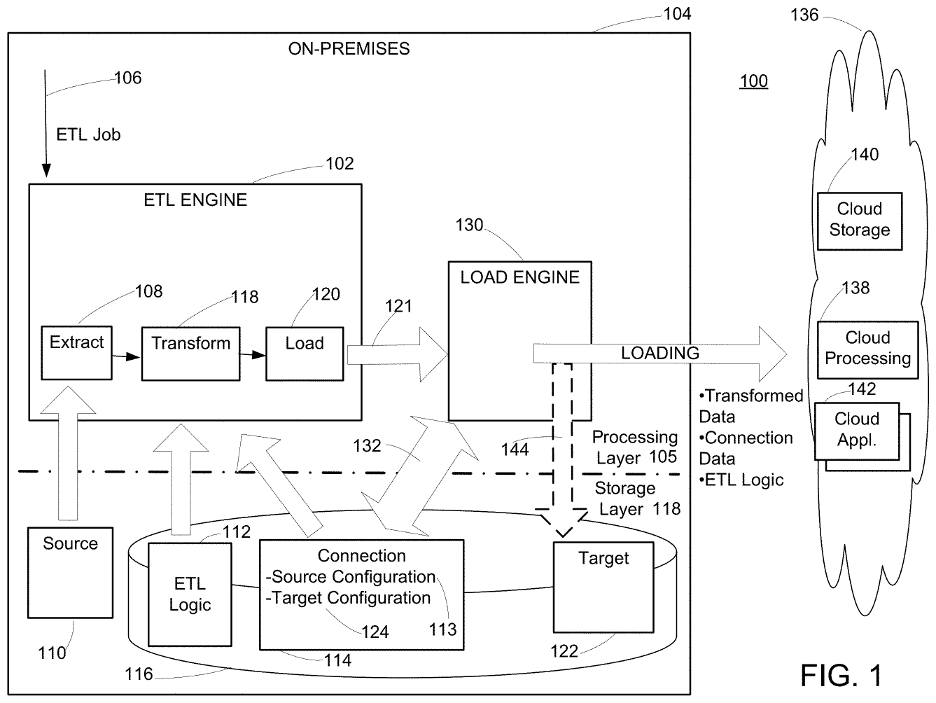

Accordingly, embodiments leverage on-premises ETL jobs to allow efficient remote processing while conserving effort. FIG. 1 shows a simplified view of an example system that is configured to implement cloud processing according to an embodiment.

Specifically, system 100 comprises an ETL engine 102 that is located on-premises 104 in processing layer 105. The ETL engine receives an ETL job 106.

The ETL engine processes the ETL job to extract 108 data from a local source 110 that is located on-premises in storage layer 111. This extraction is performed according to ETL logic 112 and source configuration 113 of connection data 114 that is stored locally on-premises in non-transitory computer readable storage medium 116.

The ETL engine may be configured to transform 118 the extracted data in a certain manner dictated by the ETL logic. Such transformations can include, but are not limited to, (hierarchy) flattening, pivot transformations, and/or data quality transformations.

The ETL engine is also configured to load 120 the transformed data 121 to a particular local target 122 that is also located on-premises. The loading may be according to a target configuration 124.

Load engine 130, however, is positioned between the ETL engine and the local target and posed to intercept the transformed data. The load engine references 132 the connection data, and in response performs loading 134 to forward the transformed data, the ETL logic, and connection data to cloud 136 that is remote from the on-premises environment in which the original ETL job is processed.

In particular, the transformed data, ETL logic, and connection data are received by cloud processing platform 138. One example of such a cloud processing platform is SAP Data Intelligence available from SAP SE of Walldorf, Germany.

The cloud processing platform is configured to store the transformed data in cloud storage 140. The transformed data may be accessed by cloud application(s) 142 for further processing. For example, such further processing may comprise Artificial Intelligence (AI) or Machine Learning (ML) operations.

In this manner, effort previously undertaken to set up the local ETL job on-premises, is leveraged to allow processing in the cloud. This eases the burden of establishing cloud processing for the on-premises data, thereby reducing cost.

FIG. 1 further shows that in some embodiments, the Load Engine may be configured to also forward 144 the transformed data on for storage in the original local target designated by the ETL job.

As described later below in connection with a particular example, in some embodiments an ETL job may be marked in the ETL tool as an input adapter for a flowgraph running in the cloud, which utilizes all the development (source/target setup, business logic, etc.) that went into that job. The load engine in the form of hidden REST-based loader(s) may be generated to communicate output data of the job, so it can be read by a cloud intelligence system. Such a hidden REST-based loader may be provided in addition to (or instead of, depending on the particular embodiment) a local loader (e.g., of an on-premises HANA database).

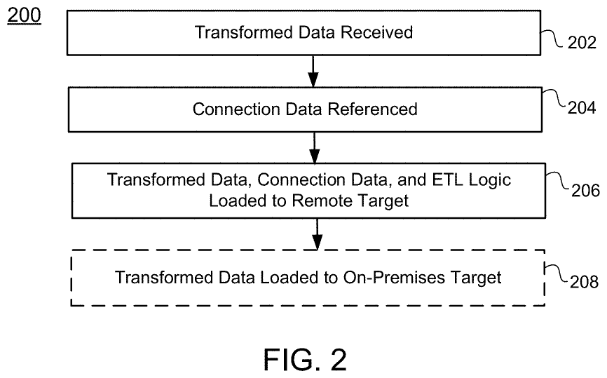

FIG. 2 is a flow diagram of a method 200 according to an embodiment. At 202, transformed data is received on-premises (e.g., from a local ETL engine). At 204, connection data is referenced.

At 206, based upon the connection data, the transformed data, the connection data, and ETL logic stored locally on-premises, are forwarded to a remote location for further processing. At 208 the transformed data may also be stored on-premises at a local target.

Systems and methods according to embodiments, may avoid one or more issues that can be associated with remote processing of data on the cloud. In particular, embodiments allow for re-use of efforts that have already been made to establish a local ETL job.

Further details regarding the leveraging of on-premises ETL data in order to perform cloud processing according to various embodiments, are now provided in connection with the following example.

### EXAMPLE

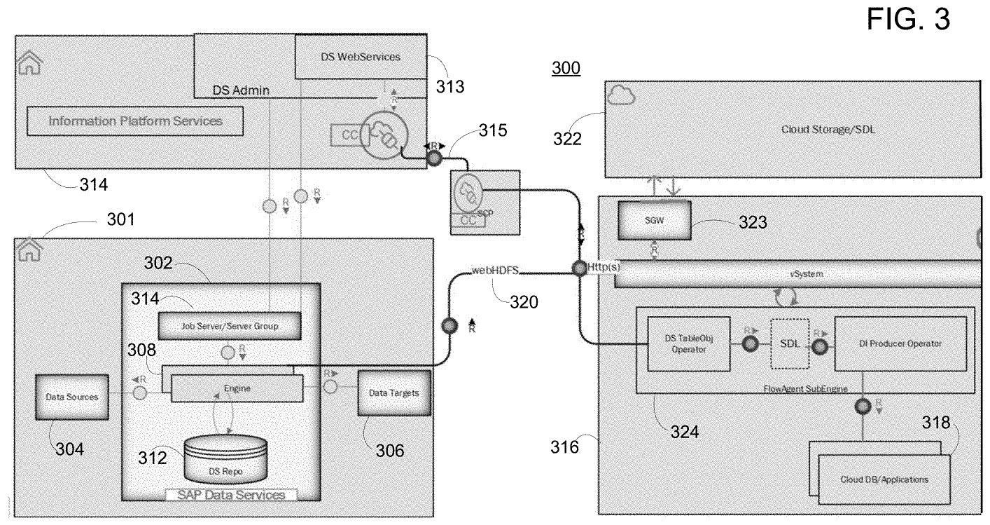

FIG. 3 shows a simplified block diagram of a system 300 according to an embodiment. Here, the ETL job located on-premises 301, is performed by the SAP Data Services (DS) application 302 available from SAP SE of Walldorf, Germany The data source 304 is a mainframe or database available from Oracle Corp. of Redwood Shores, Calif. The local on-premises data target 306 is the HANA in-memory database also available from SAP SE.

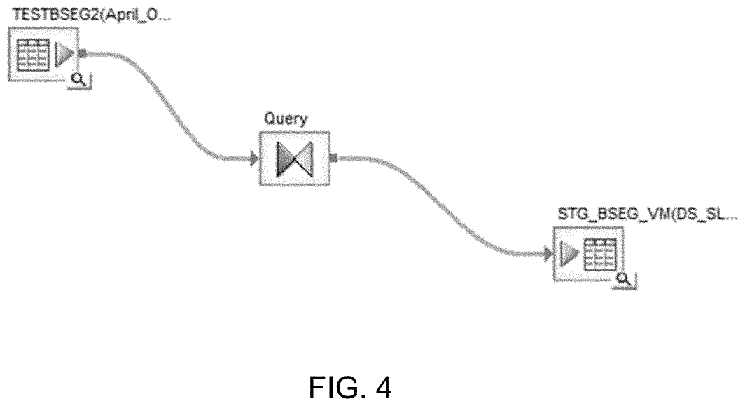

FIG. 4 shows a simplified view of the on-premises ETL job. This is a Data Services job ORA_to_HANA, that reads from an Oracle database table, processes it and stores in a HANA database, all on-premises.

The ETL engine 308 reads data from an Oracle database/Mainframe database table. The ETL engine processes the source data using ETL supported transformations, which may include but are not limited to:

hierarchy flattening,
pivot transform,
data quality transforms.
The ETL engine then stores data in a target, such as the on-premises HANA database.

As part of this ETL function, the SAP DS may connect to one or more:

databases (e.g., relational and in-memory databases),
applications,
files,
web services,
mainframes.

SAP DS may comprise DS Repository 312. This repository stores DS Metadata (e.g., jobs, dataflows, Datastores and metrics).

SAP DS may further comprise DS JobServer 314. The SAP Data Services Job Server starts the data movement (ETL) engine that integrates data from multiple heterogeneous sources, performs complex data transformations, and manages extractions and transactions from ERP systems and other sources. The SAP DS tool also provides a rich set of transforms that allow Data Integration and Data Quality, Data Profiling, and Text Data Processing functionality.

The DS Datastore and system configuration are tools for reducing the configurations required to execute the same logic against different datastore environments. Based upon configurations, migration between development phases becomes faster and more simplified.

For example, DS substitution parameters are variables which can be used across multiple jobs/objects. Once set, the value of a DS substitution parameter is subsequently preserved to allow access across DS Objects.

In the attributes, the specific ETL job is marked as Web Service-enabled. This is an indication that the results of processing should be sent via Web Services 313 of Information Platform Services 314 and Cloud Connector (CC) 315, to SAP Data Intelligence (DI) 316 that is located in the cloud.

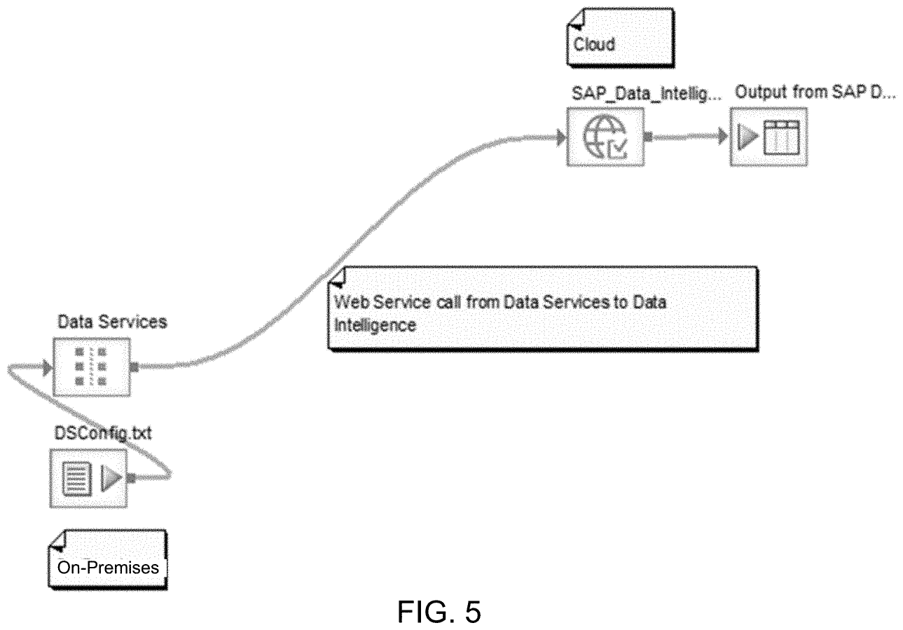

As shown in FIG. 5, the connection information to SAP DI is in the Data Services configuration file: DSConfig.txt. Thus, previous installation of Oracle and HANA drivers serves to configure connections and processing logic as part of an on-premises ETL job.

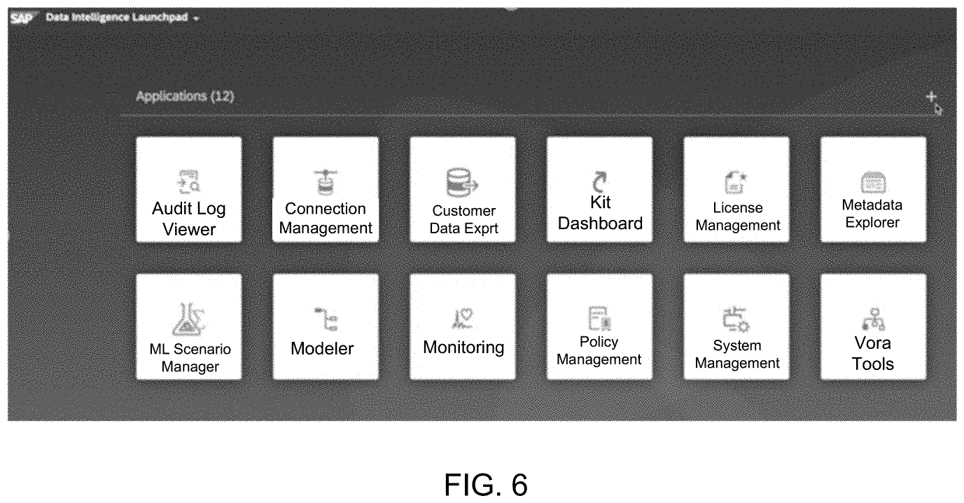

Now, embodiments allow the remote SAP Data Intelligence located off-premises, to leverage this on-premises ORA_to_HANA job, with its existing logic and connection setup. Embodiments allow the on-premises ETL job to be used as a source to perform additional data enhancements. Such additional data enhancements can include Machine Learning (ML) and/or Artificial Intelligence (AI) Operations for cloud DB applications 318. FIG. 6 shows a variety of remote applications that may process data on the cloud from the ETL job.

This exemplary embodiment enhances the output of ETL tools to be sent via REST Web Services 320 to a cloud data processing system — here SAP Data Intelligence (DI) available from SAP SE. The target for the ETL job on the cloud in DI is Kafka, as stored in the Symantec Data Lake (SDL) cloud storage 322 accessed via Storage Gateway (SGW) 323.

Thus according to embodiments, an ETL job is marked in the ETL tool as an input adapter for a flowgraph running in a FlowAgent (FL) 324 in the cloud, which utilizes the effort (source setup, target setup, business logic, etc.) that went into that on-premises ETL job. This exemplary embodiment generates REST-based loader(s) duplicating output data of the on-premises ETL job, so it can be read by a cloud intelligence system. Depending upon the particular embodiment, this hidden REST-based loader may be provided in addition to, or instead of, the HANA loader for on-premises ETL.

In this particular embodiment, the staging area size used to move on-premises data from DS to the on cloud SAP DI, is one TB. The Comma-Separated Value (CSV) file format may be used for caching/staging data.

Embodiments thus allow the on-premises job with entire ETL business logic to be used as an input to SAP DI flowgraph. That DI flowgraph can perform further processing, for example, enhancing the data using ML/AI operators.

Returning now to FIG. 1, there the particular embodiment is depicted with the load engine as being located outside of the database. However, this is not required.

Rather, alternative embodiments could leverage the processing power of an in-memory database engine (e.g., the in-memory database engine of the HANA in-memory database available from SAP SE), in order to perform various functions as described above.

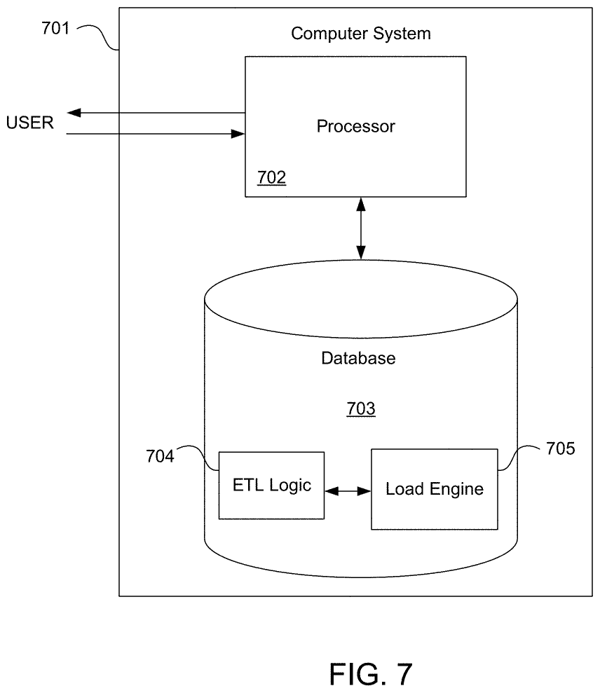

Thus FIG. 7 illustrates hardware of a special purpose computing machine configured to leverage on-premises ETL for cloud processing according to an embodiment. In particular, computer system 701 comprises a processor 702 that is in electronic communication with a non-transitory computer-readable storage medium comprising a database 703. This computer-readable storage medium has stored thereon code 705 corresponding to a load engine. Code 704 corresponds to ETL logic. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

### Example 1. Computer Implemented System and Methods Comprising

receiving data transformed according to Extract, Transform, and Load (ETL) logic stored in an on-premises non-transitory computer readable storage medium; referencing connection data stored in the on-premises non-transitory computer readable storage medium; and
loading the data, the ETL logic, and the connection data to a location remote from the on-premises non-transitory computer readable storage medium.

Example 2. The computer implemented system and method of Example 1 further comprising communicating the data for storage at a local target on-premises.

Example 3. The computer implemented system and method of Example 2 wherein the local target comprises the on-premises non-transitory computer readable storage medium.

Example 4. The computer implemented system and method of Example 3 wherein the on-premises non-transitory computer readable storage medium comprises an in-memory database.

Example 5. The computer implemented system and method of Example 4 wherein the loading is performed by an in-memory database engine of the in-memory database.

Example 6. The computer implemented system and method of Examples 1, 2, 3, 4, or 5 wherein the loading is performed by a Representational State Transfer (REST) loader.

Example 7. The computer implemented system and method of Examples 1, 2, 3, 4, 5, or 6 wherein the connection data comprises an Open Database Connectivity (ODBC) connection.

Example 8. The computer implemented system and method of Examples 1, 2, 3, 4, 5, or 6 wherein the connection data comprises a File Transfer Protocol (FTP).

Example 9. The computer implemented system and method of Examples 1, 2, 3, 4, 5, 6, 7, or 8 wherein the ETL logic is configured to perform:

flattening;
pivot transform; and/or
data quality transform.

Example 10. The computer implemented system and method of Examples 1, 2, 3, 4, 5, 6, 7, 8, or 9 wherein the on-premises non-transitory computer readable storage medium comprises an in-memory database; and

the loading is performed by an in-memory database engine of the in-memory database.

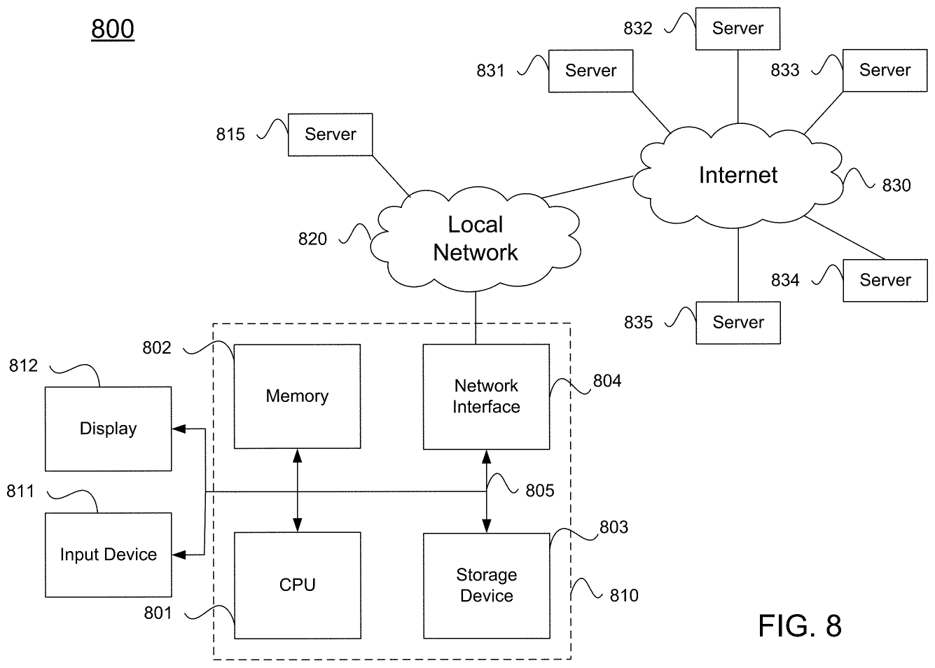

An example computer system 800 is illustrated in FIG. 8. Computer system 810 includes a bus 805 or other communication mechanism for communicating information, and a processor 801 coupled with bus 805 for processing information. Computer system 810 also includes a memory 802 coupled to bus 805 for storing information and instructions to be executed by processor 801, including information and instructions for performing the techniques described above, for example. This memory may also be used for storing variables or other intermediate information during execution of instructions to be executed by processor 801. Possible implementations of this memory may be, but are not limited to, random access memory (RAM), read only memory (ROM), or both. A storage device 803 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 803 may include source code, binary code, or software files for performing the techniques above, for example. Storage device and memory are both examples of computer readable mediums.

Computer system 810 may be coupled via bus 805 to a display 812, such as a Light Emitting Diode (LED) or liquid crystal display (LCD), for displaying information to a computer user. An input device 811 such as a keyboard and/or mouse is coupled to bus 805 for communicating information and command selections from the user to processor 801. The combination of these components allows the user to communicate with the system. In some systems, bus 805 may be divided into multiple specialized buses.

Computer system 810 also includes a network interface 804 coupled with bus 805. Network interface 804 may provide two-way data communication between computer system 810 and the local network 820. The network interface 804 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 804 sends and receives electrical, electromagnetic, or optical signals that carry digital data streams representing various types of information.

Computer system 810 can send and receive information, including messages or other interface actions, through the network interface 804 across a local network 820, an Intranet, or the Internet 830. For a local network, computer system 810 may communicate with a plurality of other computer machines, such as server 815. Accordingly, computer system 810 and server computer systems represented by server 815 may form a cloud computing network, which may be programmed with processes described herein. In the Internet example, software components or services may reside on multiple different computer systems 810 or servers 831-835 across the network. The processes described above may be implemented on one or more servers, for example. A server 831 may transmit actions or messages from one component, through Internet 830, local network 820, and network interface 804 to a component on computer system 810. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method comprising:
receiving data transformed according to Extract, Transform, and Load (ETL) logic stored in an on-premises non-transitory computer readable storage medium;
referencing connection data stored in the on-premises non-transitory computer readable storage medium; and
loading the data, the ETL logic, and the connection data to a location remote from the on-premises non-transitory computer readable storage medium.

2. A method as in claim 1 wherein the loading is performed by a Representational State Transfer (REST) loader.

3. A method as in claim 1 wherein the connection data comprises an Open Database Connectivity (ODBC) connection.

4. A method as in claim 1 further wherein the connection data comprises a File Transfer Protocol (FTP).

5. A method as in claim 1 wherein the ETL logic is configured to perform:
flattening;
pivot transform; and/or
data quality transform.

6. A method as in claim 1 further comprising communicating the data for storage at a local target on-premises.

7. A method as in claim 6 wherein the local target comprises the on-premises non-transitory computer readable storage medium.

8. A method as in claim 7 wherein the on-premises non-transitory computer readable storage medium comprises an in-memory database.

9. A method as in claim 8 wherein the loading is performed by an in-memory database engine of the in-memory database.

10. A method as in claim 1 wherein:
the on-premises non-transitory computer readable storage medium comprises an in-memory database; and
the loading is performed by an in-memory database engine of the in-memory database.

11. A non-transitory computer readable storage medium embodying a computer program for performing a method, said method comprising:
receiving data transformed according to Extract, Transform, and Load (ETL) logic stored in an on-premises non-transitory computer readable storage medium; and
referencing connection data stored in the on-premises non-transitory computer readable storage medium; and
loading the data, the ETL logic, and the connection data by a Representational State Transfer (REST) loader to a location remote from the on-premises non-transitory computer readable storage medium.

12. A non-transitory computer readable storage medium as in claim 11 wherein the connection data comprises an Open Database Connectivity (ODBC) connection or a File Transfer Protocol (FTP).

13. A non-transitory computer readable storage medium as in claim 11 wherein the ETL is configured to perform flattening, pivot transform, and/or data quality transform.

14. A non-transitory computer readable storage medium as in claim 11 wherein the on-premises non-transitory computer readable storage medium comprises a database.

15. A computer system comprising:
one or more processors;
a software program, executable on said computer system, the software program configured to cause an on-premises in-memory database engine of an on-premises in-memory database to:
receive data transformed according to Extract, Transform, and Load (ETL) logic stored in the on-premises in-memory database;
reference connection data stored in the on-premises in-memory database; and
load the data, the ETL logic, and the connection data to a location remote from the on-premises in-memory database.

16. A computer system as in claim 15 wherein the on-premises in-memory database engine is configured to load the data according to a Representational State Transfer (REST).

17. A computer system as in claim 15 wherein the connection data comprises an Open Database Connectivity (ODBC) connection or a File Transfer Protocol (FTP).

18. A computer system as in claim 15 wherein the ETL is configured to perform flattening, pivot transform, and/or data quality transform.

19. A computer system as in claim 15 wherein the in-memory database engine is further configured to communicate the data for storage at a local target on-premises.

20. A computer system as in claim 15 wherein the data is in a Comma-Separated Value (CSV) format.
